(19) United States
(12) Patent Application Publication
(10) Pub. No.: US 2023/0161158 A1
(43) Pub. Date: May 25, 2023

(54) OPTICAL SYSTEM OF AUGMENTED REALITY HEAD-UP DISPLAY

(71) Applicant: WAYRAY AG, Zürich (CH)

(72) Inventors: Andrey Mikhailovich BELKIN, Zürich (CH); Kseniia Igorevna LVOVA, Moscow (RU); Vitaly PONOMAREV, Zürich (CH); Anton Alekseevich SHCHERBINA, Zürich (CH); Mikhail SVARYCHEUSKI, Zürich (CH)

(73) Assignee: WAYRAY AG, Zürich (CH)

(21) Appl. No.: 17/546,388

(22) Filed: Dec. 9, 2021

(30) Foreign Application Priority Data
Nov. 22, 2021 (GB) 2116786.1

(51) Int. Cl. G02B 27/01; G02B 5/32

(52) U.S. Cl. CPC G02B 27/0172; G02B 5/32; G02B 2027/0174

(57) ABSTRACT

An optical system includes a picture generation unit (PGU), a correcting optical unit configured to create, in a direction of a horizontal field of view (HFoV), a monotonic variation of an optical path length of light rays propagating from the PGU, and a combiner configured to redirect light rays propagating from the correcting optical unit toward an eye box, producing one or more virtual images observable from the eye box. The optical system provides a virtual image surface inclined in the direction of the HFoV for displaying the virtual images. The virtual image surface has a non-zero angle between projections on a horizontal plane defined by a first axis perpendicular to the virtual image surface and extending through an arbitrary intersection point on the virtual image surface, and a second axis parallel to a line of sight and extending from the eye box through the intersection point.

### RELATED APPLICATIONS

The present application claims priority to United Kingdom Patent Application No. 2116786.1 filed on Nov. 22, 2021, the contents of which is hereby incorporated by reference in its entirety.

### FIELD

Embodiments discussed herein are generally related to optics, head-up display (HUDs), and augmented reality (AR) systems, and in particular, to configurations and arrangements of optical elements and devices to enhance and/or improve visual ergonomics by improving stereoscopic depth of field.

### BACKGROUND

Optical systems of see-through head-up displays provide the ability to present information and graphics to an observer without requiring the observer to look away from a given viewpoint or otherwise refocus his or her eyes. In such systems, the observer views an external scene through a combiner. The combiner allows light from the external scene to pass through while also redirecting an image artificially generated by a projector so that the observer can see both the external light as well as the projected image at the same time. The projected image can include one or more virtual objects that augment the observer's view of the external scene, which is also referred to as augmented reality (AR).

### BRIEF DESCRIPTION OF THE DRAWINGS

FIG. 1 is a block diagram of an AR display environment including an optical system, in accordance with an embodiment of the present disclosure.

FIG. 2 is a schematic diagram of the optical system of FIG. 1, in accordance with some embodiments of the present disclosure.

FIG. 3 is a top view of a virtual image surface inclined in the direction of a horizontal field of view and produced by the optical system of FIGS. 1 and 2, in accordance with an embodiment of the present disclosure.

FIGS. 4A and 4B are schematic diagrams of a correcting optical unit of the optical system of FIG. 1, in accordance with an example of the present disclosure.

FIG. 5 is a front view and a top view of a virtual image surface inclined in the direction of a horizontal field of view and produced by the optical system of FIG. 1, in accordance with some embodiments of the present disclosure.

FIG. 6 shows an example transformation of a local coordinate system in spatial relation to components of the optical system of FIG. 1, in accordance with an embodiment of the present disclosure.

FIG. 7 shows estimations of a stereoscopic depth of field for the optical system of FIG. 1, in accordance with some embodiments of the present disclosure.

FIG. 8 shows estimations of a usable size of a virtual object, which is not perceived as inclined, generated by the optical system of FIG. 1, in accordance with some embodiments of the present disclosure.

FIGS. 9A and 9B show example design parameters for the optical system of FIGS. 1, 4A and 4B, in accordance with an embodiment of the present disclosure.

FIGS. 10A and 10B show example holographic optical element (HOE) recording parameters for the combiner of the optical system of FIG. 1 including the correcting optical unit of FIGS. 4A and 4B, in accordance with an embodiment of the present disclosure.

FIGS. 11A and 11B are schematic diagrams of a correcting optical unit of the optical system of FIG. 1, in accordance with another example of the present disclosure.

FIG. 12A shows a surface sag of an example optical element surface in the direction of a vertical field of view of the optical system of FIG. 1 including the correcting optical unit of FIGS. 11A and 11B, in accordance with an embodiment of the present disclosure.

FIG. 12B shows a surface sag of an example optical element surface in the direction of a horizontal field of view of the optical system of FIG. 1 including the correcting optical unit of FIGS. 11A and 11B, in accordance with an embodiment of the present disclosure.

FIG. 13 shows an example total shape of an asymmetrical freeform surface of an example optical element of the optical system of FIG. 1 including the correcting optical unit of FIGS. 11A and 11B, in accordance with an embodiment of the present disclosure.

FIGS. 14A and 14B are schematic diagrams of a correcting optical unit of the optical system of FIG. 1, in accordance with yet another example of the present disclosure.

FIG. 15A shows a surface sag of an example optical element surface in the direction of a vertical field of view of the optical system of FIG. 1 including the correcting optical unit of FIGS. 14A and 14B, in accordance with an embodiment of the present disclosure.

FIG. 15B shows a surface sag of an example optical element surface in the direction of a horizontal field of view of the optical system of FIG. 1 including the correcting optical unit of FIGS. 14A and 14B, in accordance with an embodiment of the present disclosure.

FIG. 16 shows an example total shape of an asymmetrical freeform surface of an example optical element of the optical system of FIG. 1 including the correcting optical unit of FIGS. 14A and 14B, in accordance with an embodiment of the present disclosure.

FIG. 17 shows deviation from a best fit sphere of an example optical element surface of the optical system of FIG. 1 including the correcting optical unit of FIGS. 14A and 14B, in accordance with an embodiment of the present disclosure.

FIG. 18 shows stereoscopic depth of field with respect to a horizontal field of view in the optical system of FIG. 1, in accordance with some embodiments of the present disclosure.

FIG. 19 shows three-dimensional virtual image sizes and positions within a horizontal field of view for several scenes in a field of view of the optical system of FIG. 1, in accordance with some embodiments of the present disclosure.

FIG. 20 shows three-dimensional virtual image sizes and positions within horizontal and vertical fields of view for several scenes in a field of view of the optical system of FIG. 1, in accordance with some embodiments of the present disclosure.

FIG. 21 is a chart showing a combiner focal length versus a volume of an optical system for each of several virtual image distances of the optical system of FIG. 1, in accordance with some embodiments of the present disclosure.

FIG. 22 shows a horizontal field of view for a side-view optical system, in accordance with an embodiment of the present disclosure.

FIG. 23 shows an example stereoscopic depth of field relative to angles of inclination of a virtual image surface.

FIGS. 24A-B show example scenes of a three-dimensional virtual image size and depth from an observer for the angles of inclination of the virtual image surface in FIG. 23.

FIG. 25 shows an example stereoscopic depth of field relative to angles of field of view of a virtual image surface.

FIGS. 26A-B show example scenes of a three-dimensional virtual image size and depth from an observer for the fields of view of the virtual image surface in FIG. 25.

FIG. 27 shows a limit of a vertical field of view with respect to the size of a combiner.

### DETAILED DESCRIPTION

An optical system, in accordance with an example of the present disclosure, is compact and can produce augmented reality in a head-up display with a relatively high stereoscopic depth of field overcoming limitations on the usable size of the virtual objects which does not exceed a stereo-threshold and are not perceived as inclined by an observer. In an example, the optical system includes a picture generation unit, a correcting optical unit, and a combiner. The correcting optical unit is configured to create, in a direction of a horizontal field of view, a monotonic variation of an optical path length of light rays propagating from the picture generation unit. The combiner is configured to redirect light rays propagating from the correcting optical unit toward an eye box, thereby producing one or more virtual images observable from the eye box. The optical system provides a virtual image surface inclined in the direction of the horizontal field of view for displaying the one or more virtual images at different distances from an observer, such that a virtual image on a first side of the virtual image surface appears closer to the eye box than a virtual image on a second side of the virtual image surface. The virtual image surface has a non-zero angle between projections on a horizontal plane defined by a first axis and a second axis, the first axis being perpendicular to the virtual image surface and extending through an arbitrary intersection point on the virtual image surface, and the second axis being parallel to a line of sight and extending through an arbitrary intersection point on the virtual image surface. The techniques provided herein are particularly useful in the context of an automotive vehicle. Numerous configurations and variations and other example use cases will be appreciated in light of this disclosure.

### 1. Overview

As noted above, certain types of optical systems provide a head-up display using a combiner that combines light from the external (e.g., real world) environment with artificially generated images, including virtual objects or symbols that are projected into the field of view of an observer. Such a display is also referred to as an augmented reality head-up display (AR HUD). To provide a natural, fully integrated three-dimensional (stereoscopic) visual perception of the virtual objects within the external environment, an AR HUD can be arranged such that an observer perceives the virtual objects at different distances along a virtual image surface, which provides a sense of depth of those objects within the augmented reality scene. As used herein, the term virtual image surface refers to an imaginary surface (planar or non-planar) upon which virtual objects and other virtual images appear to lie when viewed from the eye box inside the field of view area. In general, the visual ergonomics of AR HUD improve as the stereoscopic depth of field increases. For example, a large stereoscopic depth of field increases the number of virtual objects that can simultaneously appear to be at different distances in front of an observer.

A standard AR HUD achieves stereoscopic depth of field by inclining a virtual image surface with the respect to a road or ground surface (the inclination of the virtual image surface in a direction of a vertical field of view). In such an AR HUD, virtual objects displayed in a lower portion of the field of view appear to be closer to the observer than virtual objects are in the upper portion of the field of view. However, some existing AR HUDs have a relatively small stereoscopic depth of field due, for example, to structural limitations of the HUD on the maximum size of the vertical field of view (FoV) and the spatial orientation of the virtual image surface. A structural limitation on the maximum size of the vertical FoV of the HUD relates to a combiner size. In existing automotive HUDs, the combiner inclination angle is more than 60°, so the combiner size is at least twice larger than the combiner's projection on the vertical plane. So, a vertical field of view increase leads to the combiner size increase, the numerical aperture increase, and hence the fast increase of aberrations (especially, increase of the astigmatism aberration). Such limitations, as well as human binocular vision limitations, can also limit the maximum usable size of the virtual objects which are not perceived as inclined. For instance, virtual image surfaces inclined in the direction of the vertical field of view enable a limited stereoscopic depth of field due to the limited size of a vertical field of view of the HUD. With a virtual image surface inclined in the direction of the vertical field of view, the stereoscopic depth of field can be increased by increasing the inclination angle of the virtual image surface. However, increasing the inclination angle relative to the direction of the vertical field of view reduces the usable size and/or height of the virtual objects (which are not perceived as inclined) displayed on the virtual image surface inclined in the direction of the vertical field of view. This decrease in the usable size of the virtual objects restricts an improvement of the stereoscopic depth of field in existing HUDs.

To this end, in accordance with an example of the present disclosure, an optical system is provided that is relatively compact and can produce augmented reality in a head-up display with a relatively high stereoscopic depth of field overcoming the limitations on the usable size of the virtual objects (which are not perceive as inclined) appearing in the field of view area. An example optical system includes a picture generation unit, a correcting optical unit, and a combiner. The correcting optical unit is configured to create, in a direction of a horizontal field of view, a monotonic variation of an optical path length of light rays propagating from the picture generation unit. The combiner is configured to redirect light rays propagating from the correcting optical unit toward an eye box, thereby producing one or more virtual images observable at the eye box.

The optical system thus provides a virtual image surface inclined in the direction of the horizontal field of view for displaying the one or more virtual images at different distances from the observer such that one or more virtual images on a first side of the virtual image surface appear closer to the eye box than one or more virtual images on a second side of the virtual image surface. By inclining the virtual image surface in the direction of the horizontal field of view (horizontal inclination), the stereoscopic depth of field is increased at least twofold in comparison to existing techniques, which incline the virtual image surface in the direction of the vertical field of view (vertical inclination). Such benefit refers to that horizontal field of view of existing AR HUDs is always at least twice as wide as the vertical field of view.

To produce an inclined virtual image surface, in some examples, the correcting optical unit includes a specific combination of optical elements. For example, the inclination of the virtual image surface can be achieved by inclining a lens through which the optical image passes, by using an optical surface with an asymmetrical shape forming a wedge with adjacent optical surfaces, or by using a combination of an inclined lens and an optical surface with an asymmetrical shape. In some examples, the combiner includes a holographic optical element with positive optical power, which in combination with the correcting optical unit further increases the stereoscopic depth of field. Various other examples will be apparent in light of the present disclosure.

### 2. Example Optical System

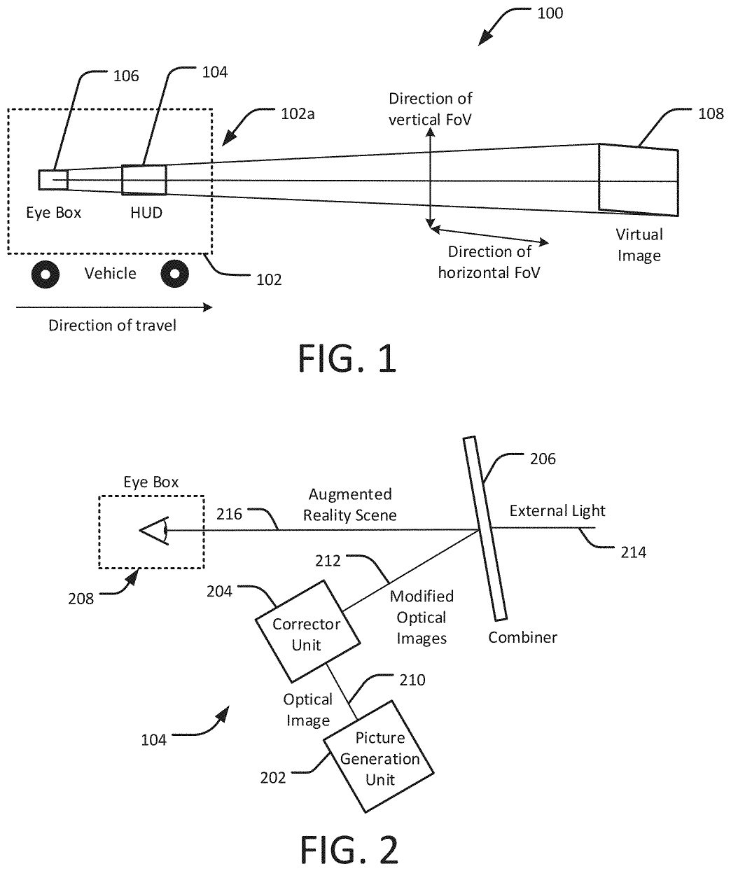

FIG. 1 is a block diagram of an augmented reality display environment 100, in accordance with an example of the present disclosure. The environment 100 includes a vehicle 102 with an optical system (such as a head-up display or HUD) 104. The vehicle 102 can be any type of vehicle (e.g., passenger vehicle such as a car, truck, or limousine; a boat; a plane). In some examples, at least a portion of the optical system 104 is mounted in the passenger vehicle 102 between (or within) a windshield 102 a and a driver, although other examples may include a second such optical system 104 mounted between a side window and a passenger as will be discussed in turn. The optical system 104 is configured to generate a virtual image 108 that is visible from an eye box 106 of the driver. The eye box 106 is an area or location within which the virtual image 108 can be seen by either or both eyes of the driver, and thus the driver's head occupies or is adjacent to at least a portion of the eye box 106 during operation of the vehicle 102. The virtual image 108 includes one or more virtual objects, symbols, characters, or other elements that are optically located ahead of the vehicle 102 such that the virtual image 108 appears to be at a non-zero distance (up to perceptible infinity) away from the optical system 104 (e.g., ahead of the vehicle 102). Such a virtual image 108 is also referred to as augmented reality when combined with light from a real-world environment, such as the area ahead of the vehicle 102.

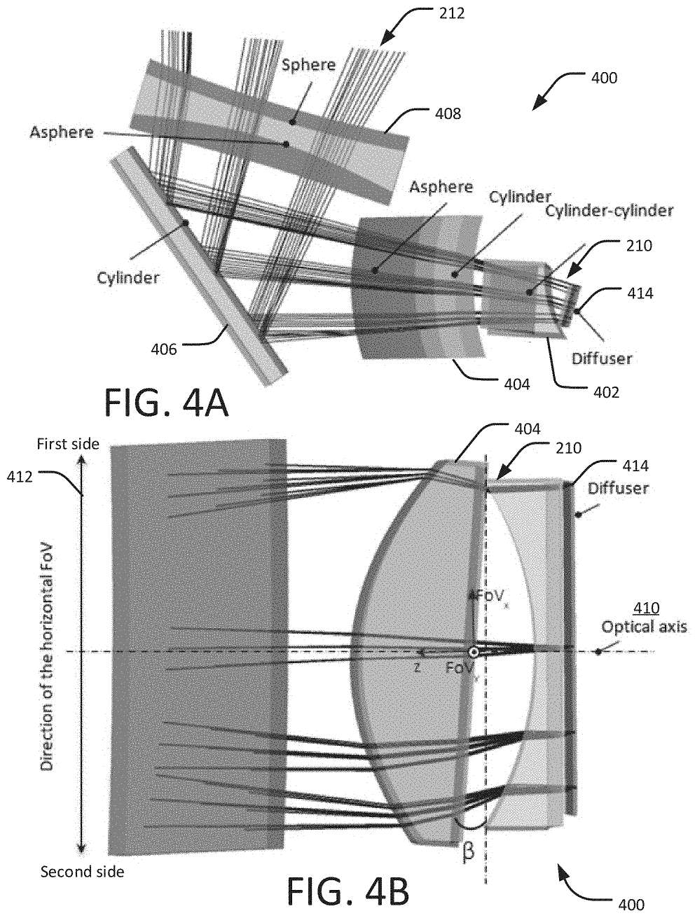

As described in further detail below, the optical system 104 produces an inclined virtual image surface that is non-perpendicular to a line of sight through the system 104 such that virtual objects on the left side of the virtual image 108 are displayed closer to a viewer than virtual objects on the right side of the virtual image 108, or such that virtual objects on the right side of the field of view of the system 104 are displayed closer to a viewer than virtual objects on the left side of the field of view of the system 104, depending on the angle of inclination of the virtual image surface in the direction of the horizontal field of view. The line of sight is a line extending from the center of the eye box area 106 into the center of the field of view area of the optical system 104. According to embodiments of the present disclosure, the optical system 104 is designed to occupy a relatively small and compact area (by volume) so as to be easily integrated into the structure of the vehicle 102. Several examples of the optical system 104 are described below with respect to FIGS. 2, 4A-B, 11A-B, and 14A-B.

FIG. 2 is a schematic diagram of the optical system 104 of FIG. 1, in accordance with an example of the present disclosure. The optical system 104 can be implemented as at least a portion of the environment 100 of FIG. 1. The optical system 104 includes a picture generation unit (PGU) 202, a correcting optical unit 204, and a combiner 206. The PGU 202 can include, in some examples, a digital micromirror device (DMD) projector, a liquid crystal on silicon (LCoS) projector, a liquid-crystal display (LCD) with laser illumination projector, a micro-electro-mechanical system (MEMS) projector with one dual-axis scanning mirror or with two single-axis scanning mirrors, an array of semiconductor lasers, a thin-film-transistor liquid-crystal display (TFT LCD), an organic light emitting diode (OLED), an Active Matrix Organic Light Emitting Diode (AMOLED), or other suitable illumination device. In some examples, the PGU 202 can further include a diffusing element or a microlens array. 100421 The PGU 206 is configured to generate and output an optical image 210, represented in FIG. 2 by a ray of light. The optical image 210 may include, for instance, one or more features (such as symbols, characters, or other elements) to be projected into, or to otherwise augment, external light 214 from a real-world scene viewable through the combiner 206. In some examples, the combiner 206 includes a holographic optical element (HOE) with a positive optical power, which can be placed on the inside surface of a windshield of the vehicle 102 or integrated into the windshield in a process of triplex production.

The optical system 104 is arranged such that the optical image 210 output by the PGU 206 passes through the correcting optical unit 204, which produces one or more modified optical images 212. The modified optical images 212 redirects to the combiner 206, then toward an eye box 208 outside of the optical system 104. The combiner 206 is further configured to permit at least some of the external light 214 to pass through the combiner 206 and combine with the redirected optical image to produce an augmented reality scene 216 visible from the eye box 208. In some examples, the augmented reality scene 216 includes an augmented reality display of the virtual image 108 of FIG. 1, where at least some objects in the virtual image 108 are perceived by the driver or observer to be located on a virtual image surface that is inclined horizontally with respect to the field of view of the AR HUD optical system.

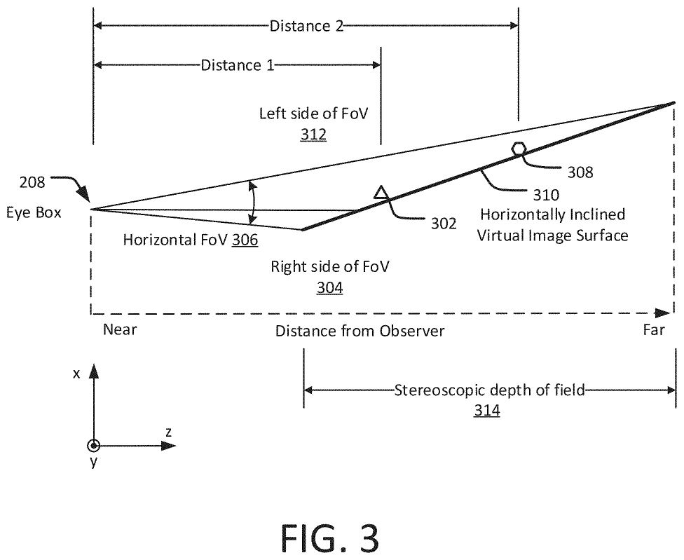

For example, such as shown in FIG. 3, the combination of the PGU 202, the correcting optical unit 204, and the combiner 206 are arranged such that one or more virtual objects 302 displayed on a right side 304 of a field of view (FoV) 306 of a horizontally inclined virtual image surface 310 appear to be closer to the eye box 208 than one or more virtual objects 308 displayed on a left side 312 of the FoV 306 of the horizontally inclined virtual image surface 310, where the right and left sides 304, 312 are defined with respect to the horizontal FoV 306 from the eye box 208. In FIG. 3, the horizontal plane (XZ) is defined with respect to a local gravity direction, where the horizontal plane approximates the surface of the earth, or with respect to a vehicle, such as a motor vehicle, a vessel, or an aircraft. A stereoscopic depth of field is defined as the range of distances of the horizontally inclined virtual image surface 310 within the horizontal field of view 306. For example, the greater the inclination of the virtual image surface 310 in the direction of the horizontal field of view, the greater the stereoscopic depth of field 314.

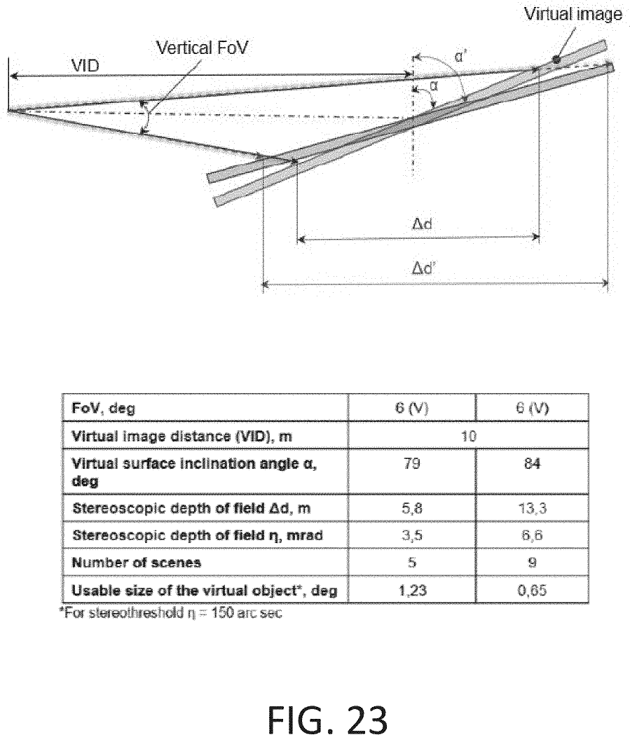

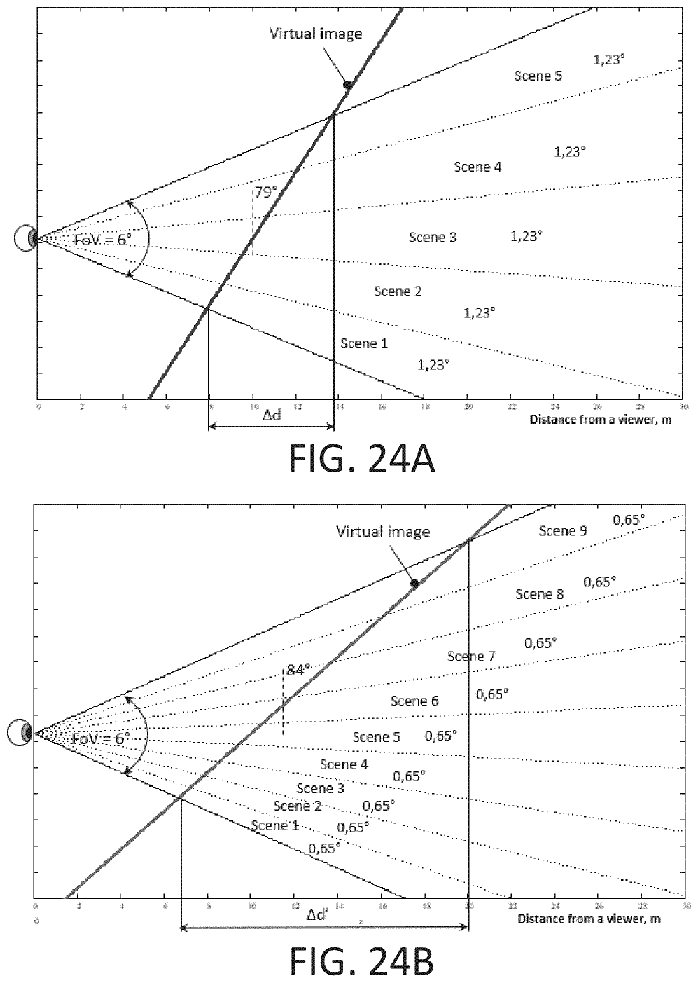

As noted above, is possible to improve stereoscopic depth of field by increasing the inclination angle of the virtual image surface 310. However, increasing the inclination angle of the virtual image surface 310 leads to a decrease in the usable size of the virtual object. As shown in FIG. 23, at a vertical field of view of 6°, an increase in the inclination angle of the virtual image surface from 79° to 85° provides an increase in stereoscopic depth of field from 3.5 mrad to 6.6 mrad, or the number of scenes increases from five to nine. However, as shown in FIGS. 24A-B, such an increase in the inclination angle from 79° (FIG. 24A) to 85° (FIG. 24B) decreases the usable size of the virtual object from 1.2° to 0.6°, respectively.

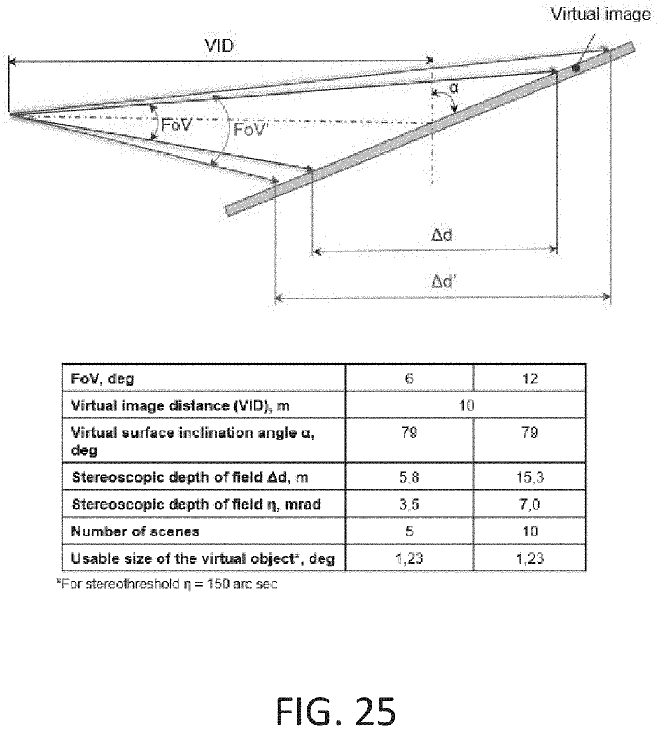

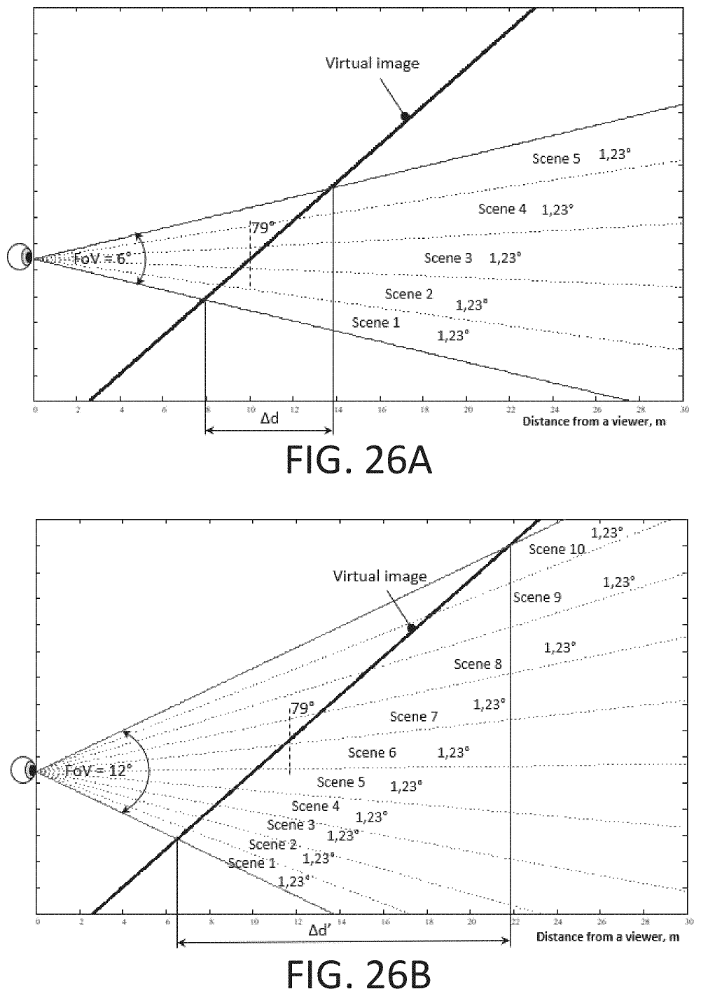

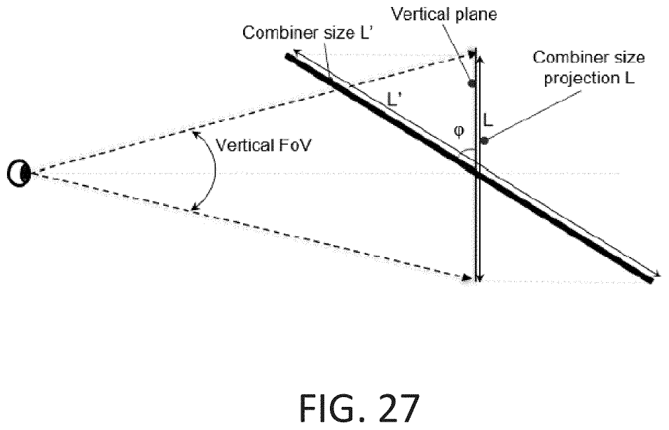

Another technique to improve stereoscopic depth of field without an influence on the usable size of the virtual object is to increase the field of view. As shown in FIG. 25, a twofold increase in the field of view from 6° to 12° leads to a twofold increase in the stereoscopic depth of field from 5.8 meters to 15.3 meters while keeping the usable size of the virtual object unchanged, such as shown in FIGS. 26A-B, respectively. However, an AR HUD has vertical field of view limitations. In existing automotive AR HUDs, the combiner inclination angle is more than 60°, so the combiner size is at least twice larger than the combiner projection on the vertical plane, such as shown in FIG. 27. This leads to an increase in the size of the combiner size, the numerical aperture, and an increase in aberrations (such as an increase of the astigmatism aberration) while increasing the vertical field of view. Also, in the case of the holographic combiner, diffraction efficiency distribution is wider in the direction of the horizontal field of view than in the direction of the vertical field of view. Thus, the horizontal field of view in existing automotive AR HUDs is at least twice larger than the vertical field of view. By contrast to existing designs, increasing the inclination of the virtual image surface in the direction of the horizontal field of view provides a significant improvement of the stereoscopic depth of field and keeps the usable size of the virtual object unchanged, such as shown in FIGS. 26A-B, where the usable size remains at 1.2° as the size of the field of view increases.

As noted above, in accordance with an embodiment of the present disclosure, the virtual image surface 310 is an imaginary surface upon which virtual objects projected from the PGU 202 appear to lie. It will be understood that the virtual image surface 310 can be inclined such as shown in FIG. 3, where the one or more virtual objects 302 displayed on the right side 304 of the field of view (FoV) 306 appear to be closer to the eye box 208 than the one or more virtual objects 308 displayed on the left side 312 of the FoV 306, or the virtual image surface 310 can be inclined such that the one or more virtual objects 302 displayed on the left side 312 of the field of view (FoV) 306 appear to be closer to the eye box 208 than the one or more virtual objects 308 displayed on the right side 304 of the FoV 306.

2.1. First Example Correcting Optical Unit of AR Optical System

FIGS. 4A and 4B are schematic diagrams of a correcting optical unit 400, in accordance with an example of the present disclosure. The correcting optical unit 400 can be implemented as at least part of the correcting optical unit 204 of FIG. 2. The correcting optical unit 400 includes a telecentric lens 402, an optical element 404 with a cylindrical surface and an aspherical surface, a cylindrical mirror 406, and an output lens 408 with an aspherical surface and a spherical surface. A telecentric lens is a compound lens that has its entrance or exit pupil at infinity, where the chief rays are parallel or substantially parallel to the local optical axis in front of or behind the lens, respectively. The optical element 404 is inclined at an angle β with the respect to a local optical axis 410 in a direction 412 of a horizontal FoV. For example, the optical element 404 can be inclined toward a first side of the horizontal FoV at an angle β, such as shown in FIG. 4B, or toward a second side of the horizontal FoV. In some examples, a diffuser 414 can be included as part of the correcting optical unit 400 or the PGU 202.

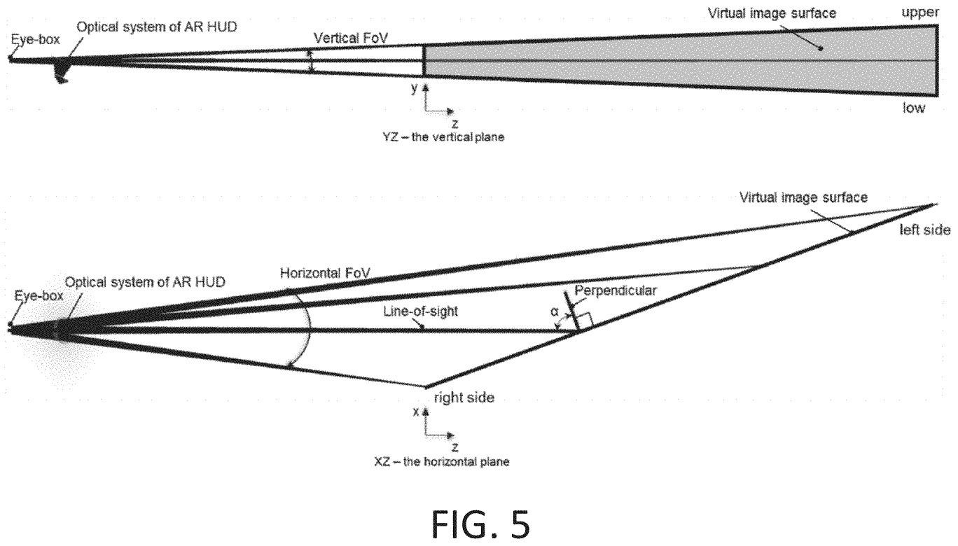

In some examples, the optical system 104 operates in monochromatic mode at a wavelength of 532 nm. Referring to FIGS. 2, 4A and 4B, the optical system 104 with the correcting optical unit 400 operates as follows. The PGU 202 projects the optical image 210 onto the diffuser 414. Rays of light from the diffuser 414 propagate through the correcting optical unit 400, where the inclined optical element 404 (e.g., inclined with respect to the local coordinate axes FoVₓ, FoV_{y}, z) creates the optical path length monotonic variation in the direction of the horizontal field of view 412, producing the modified optical images 212. The modified optical images 212 rays reach the combiner 206, which redirects the modified optical images 212 toward the eye box 208. An inclined virtual image surface, such as shown in FIG. 5, is formed by the monotonic variation of the optical path length with a non-zero angle a between the projection of a perpendicular through an arbitrary point of the virtual image surface onto the horizontal plane (defined as the X-Z plane) and the line-of-sight projection onto the horizontal plane.

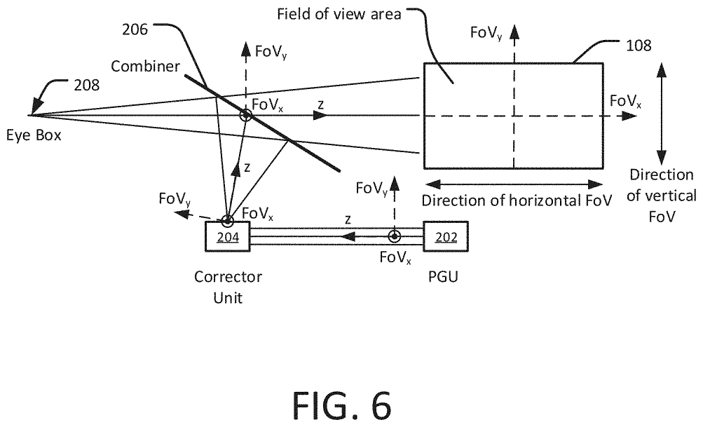

FIG. 6 shows a transformation of a local coordinate system (FoVₓ, FoV_{y}, Z) in spatial relation to components of the optical system 104 of FIG. 1, including the PGU 202, the correcting optical unit 204, and the combiner 206, in accordance with an example of the present disclosure. The direction in which the correcting optical unit 400 creates an optical path length monotonic variation relates to a local coordinate system (FoVₓ, FoV_{y}, Z) for defining the FoV, where the Z-axis coincides with the local optical axis defined as the chief ray passing through the center of the field of view area (FoVₓ, FoV_{y}).

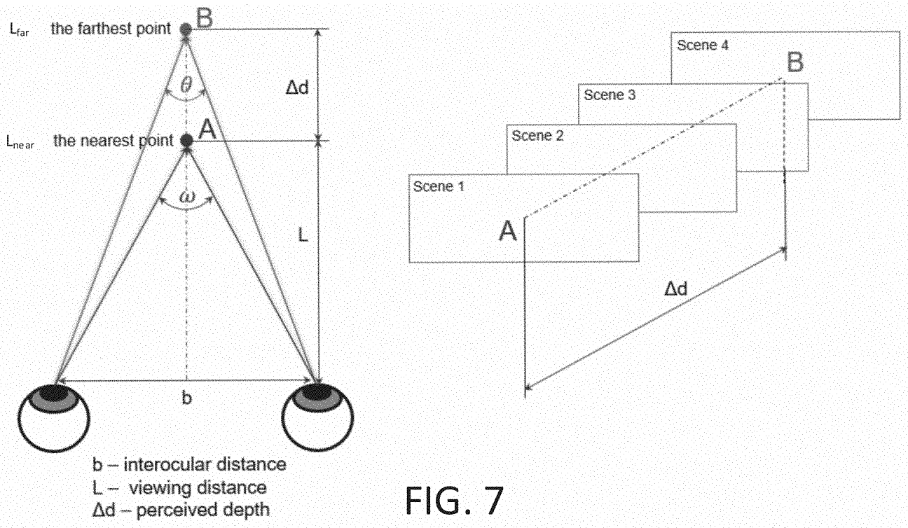

With reference to FIG. 7, estimations of a stereoscopic depth of field for the optical system 104, are as follows. The stereoscopic depth of field in a linear measure is the difference between the nearest point to an observer Lₙₑₐᵣ and the farthest point from the observer L_{far}:

Δd=L_{far}−Lₙₑₐᵣ

The stereoscopic depth of field in an angular measure is the angle η in milliradians (mrad), defined as the difference between angles ε and θ converging on the nearest point to a viewer and the farthest point to a viewer.

η=ε−θ

The stereoscopic depth of field can be estimated in a number of scenes (e.g., Scene 1, Scene 2, etc.) of a 3D virtual image placed between the nearest point to a viewer and the farthest point to a viewer. The size of each scene in a 3D virtual image is an area at a predetermined distance from a viewer where the displayed virtual objects (e.g., the letters “A” and “B” in FIG. 7) are not perceived as inclined. Each scene size is defined by the usable size of the virtual object (which are not perceived as inclined), the field of view, and the viewing distance L. Dividing the virtual image surface into several scenes demonstrates the usable size of the virtual object at a predetermined distance, the aspect ratio of the virtual object, and the position of the virtual object within the field of view.

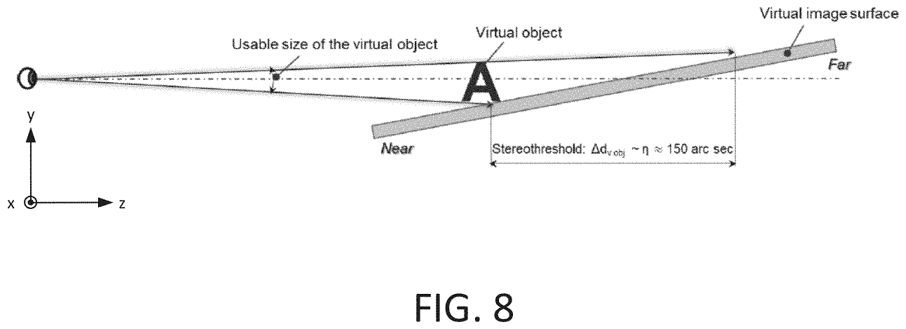

The usable size of the virtual object, which isn't perceived as inclined, is limited by the stereo-threshold of human vision, such as shown in FIG. 8. The stereo-threshold is the smallest stereoscopic depth of field that can be reliably discriminated by the observer and is based on human vision physiological properties. For example, the stereo-threshold can be approximately 150 arc-seconds. The larger the angle of inclination of the virtual image surface, the smaller the usable size of the virtual object which is not perceived as inclined by an observer.

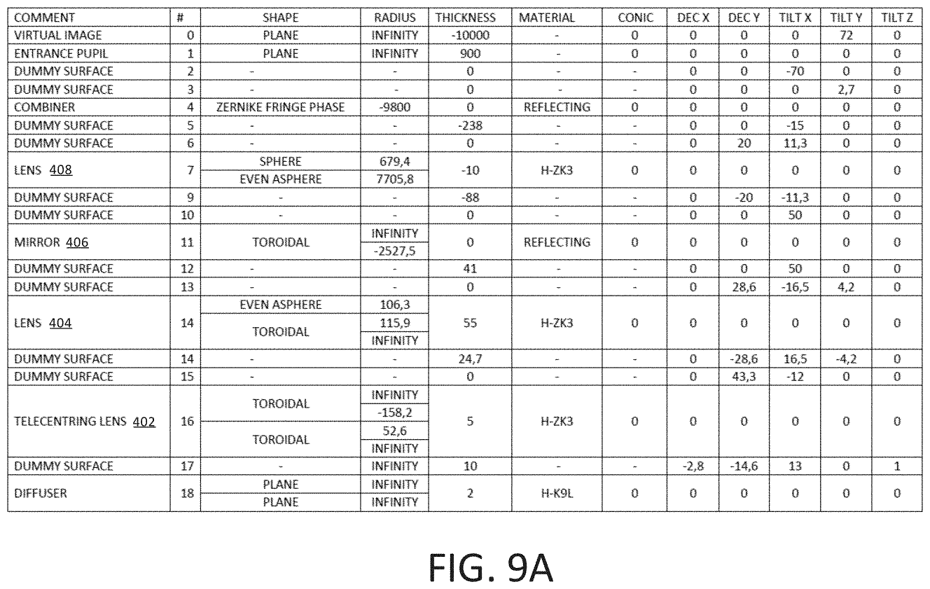

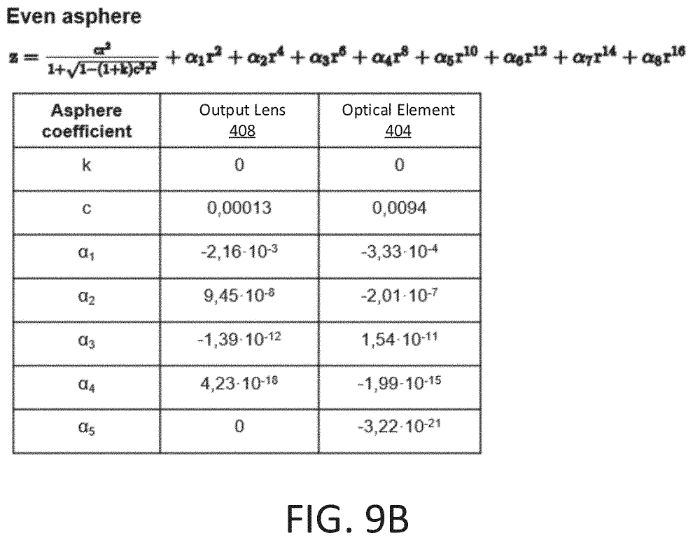

FIGS. 9A and 9B show example design parameters for the optical system 104 including the correcting optical unit 400 of FIGS. 4A and 4B for an operating wavelength of 532 nanometers, in accordance with an embodiment of the present disclosure.

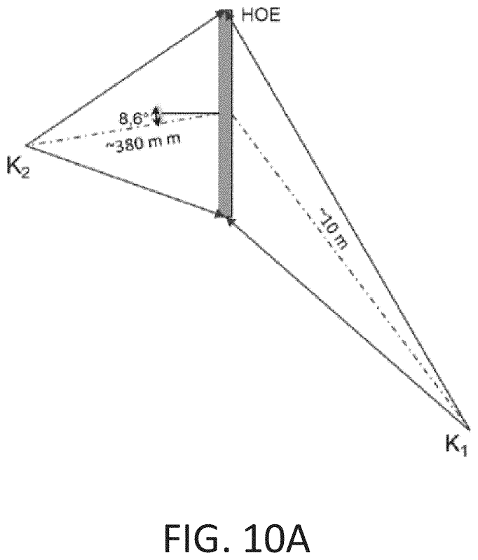

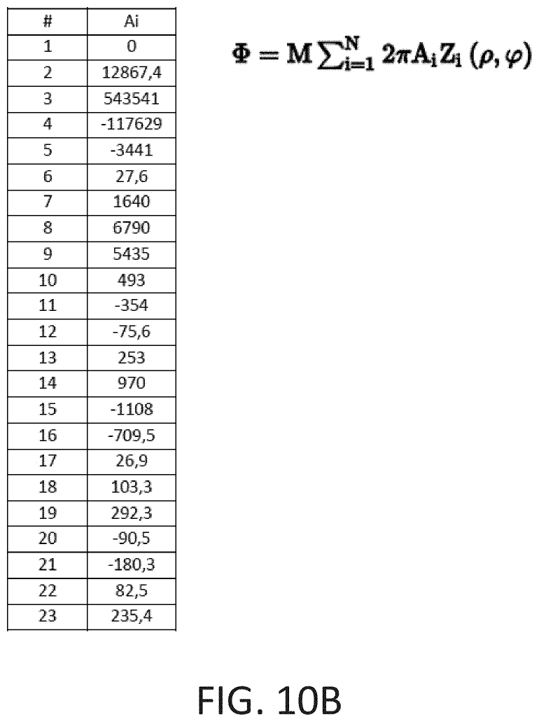

FIGS. 10A and 10B show example HOE recording parameters for the combiner 206 of the optical system 104 including the correcting optical unit 400 of FIGS. 4A and 4B for an operating wavelength of 532 nanometers, in accordance with an embodiment of the present disclosure. FIG. 10B lists example Zernike fringe coefficients of the HOE combiner.

2.2. Second Example Correcting Optical Unit of AR Optical System

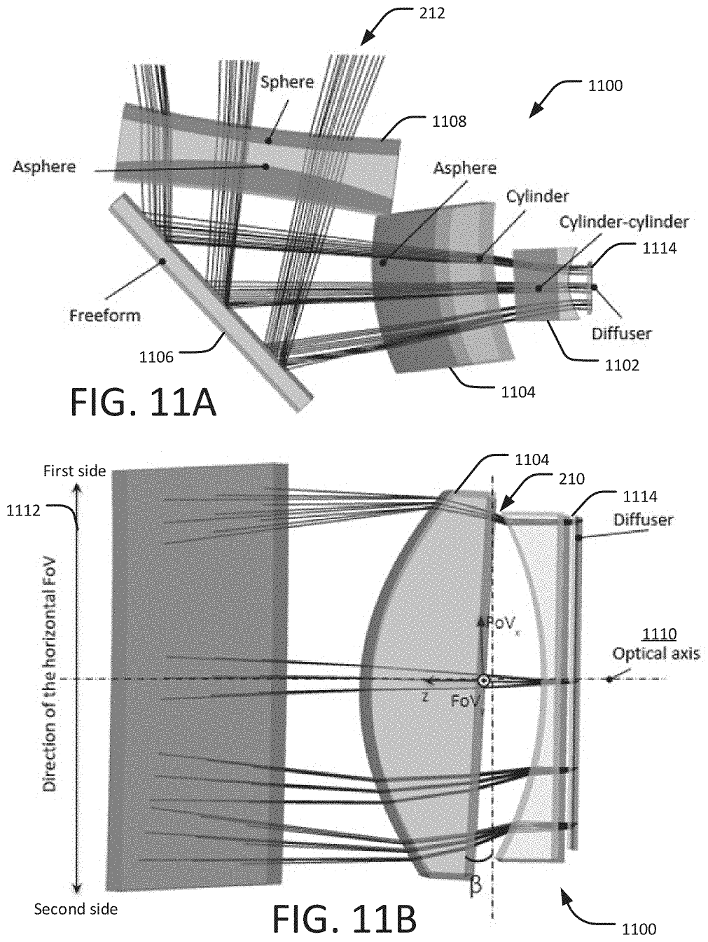

FIGS. 11A and 11B are schematic diagrams of a correcting optical unit 1100, in accordance with another example of the present disclosure. The correcting optical unit 1100 can be implemented as at least part of the correcting optical unit 204 of FIG. 2. The correcting optical unit 1100 includes a telecentric lens 1102, an optical element 1104 with a cylindrical surface and an aspherical surface, a freeform mirror 1106 (a mirror with a freeform surface shape), and an output lens 1108 with an aspherical surface and a spherical surface. The optical element 1104 is inclined at an angle β with the respect to a local optical axis 1110 in the direction of a horizontal field 1112 of view. In some examples, a diffuser 1114 can be included as part of the correcting optical unit 1100 or the PGU 202.

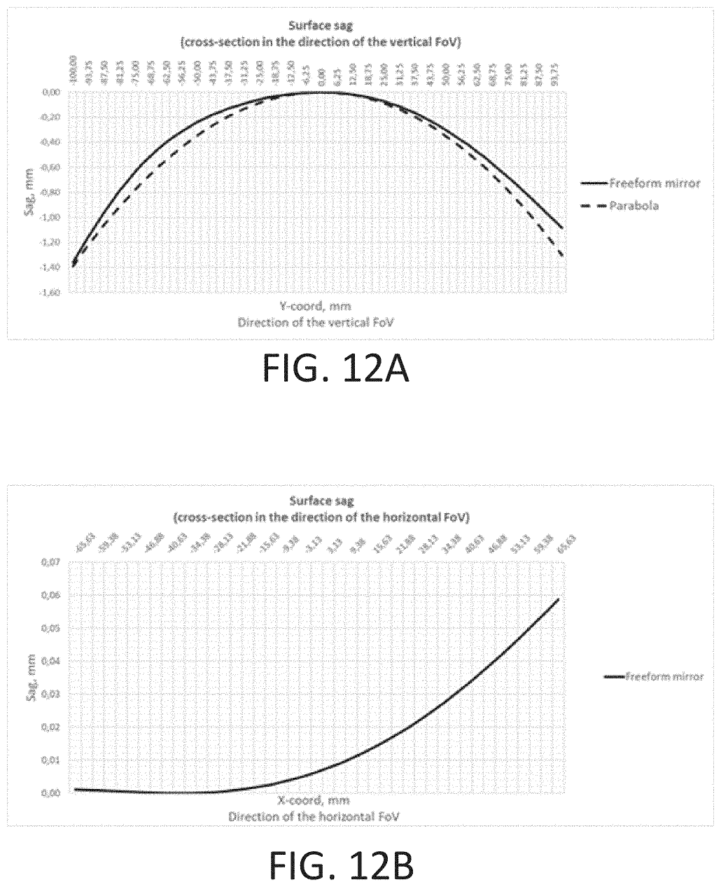

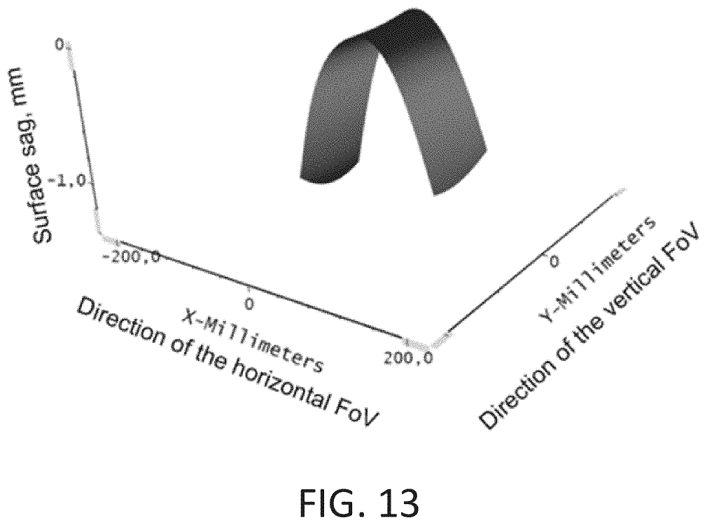

The freeform mirror 1106 has an asymmetrical surface profile forming a wedge with adjacent optical surfaces of the optical element 1104 and the output lens 1108. The cross-sectional shape of the freeform mirror 1106 in the direction of a vertical field of view can, in some examples, be close to a parabolic cylinder surface, such as shown in FIG. 12A. The cross-sectional shape of the freeform mirror 1106 in the direction of a horizontal field of view can, in some examples, have an asymmetrical profile with a maximum sag of about 60 micrometers (μm), such as shown in FIG. 12B. FIG. 13 shows an example of the total shape of the surface of the freeform mirror 1106.

Referring to FIGS. 2, 11A and 11B, the optical system 104 with the correcting optical unit 1100 operates as follows. The PGU 202 projects the optical image 210 onto the diffuser 1114. Rays of light from the diffuser 1114 propagate through the correcting optical unit 1100, where the inclined optical element 1104 and the freeform mirror 1106 create an optical path length monotonic variation in the direction of the horizontal field of view 1112, producing the modified optical images 212. The modified optical images 212 reach the combiner 206, which redirects the modified optical images 212 toward the eye box 208. An inclined virtual image surface, such as shown in FIG. 5, is formed by the monotonic variation of the optical path length with a non-zero angle α between the projection of a perpendicular through an arbitrary point of the virtual image surface onto the horizontal plane (defined as the X-Z plane) and the line-of-sight projection onto the horizontal plane.

2.3. Third Example Correcting Optical Unit of AR Optical System

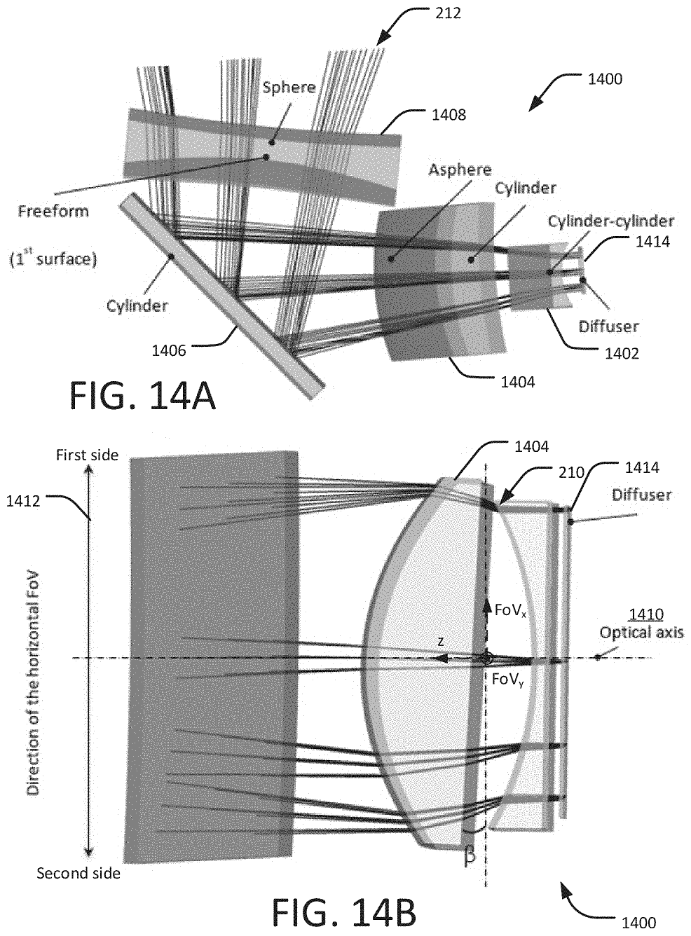

FIGS. 14A and 14B are schematic diagrams of a correcting optical unit 1400, in accordance with yet another example of the present disclosure. The correcting optical unit 1400 can be implemented as at least part of the correcting optical unit 204 of FIG. 2. The correcting optical unit 1400 includes a telecentric lens 1402, an optical element 1404 with a cylindrical surface and an aspherical surface, a cylindrical mirror 1406, and an output lens 1408 with a freeform surface and a spherical surface. The optical element 1404 is inclined at an angle β with the respect to a local optical axis 1410 in the direction of a horizontal field 1412 of view. In some examples, a diffuser 1414 can be included as part of the correcting optical unit 1400 or the PGU 202.

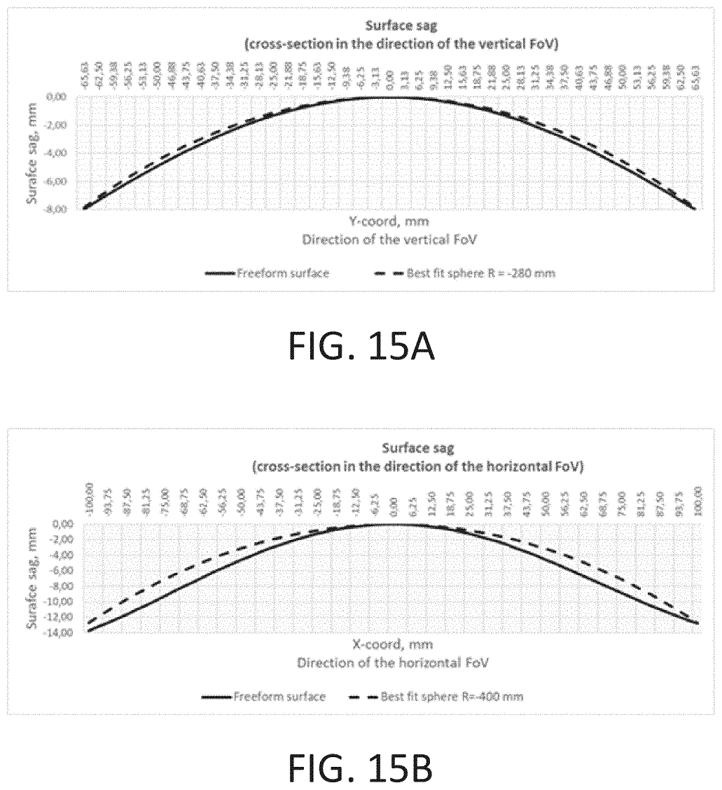

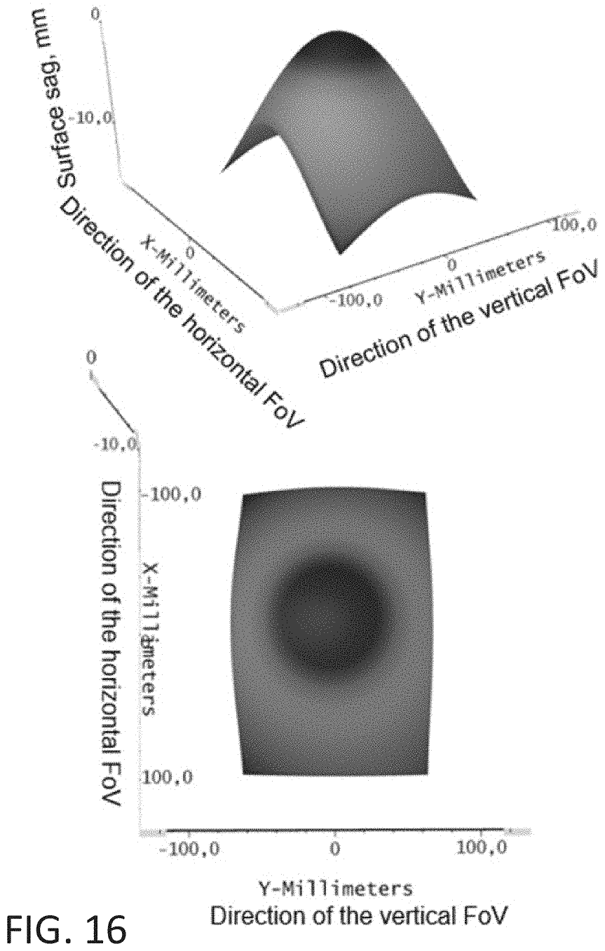

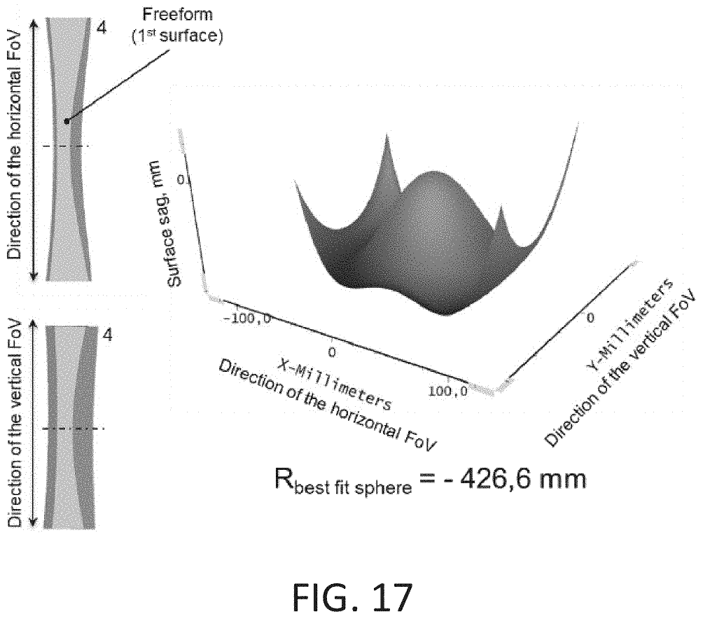

The freeform surface of the output lens 1408 in the direction of ray propagation has an asymmetrical freeform profile and forms a wedge with adjacent optical surfaces of the output lens 1408 and the mirror 1406 in the direction of the horizontal field of view. The cross-sectional shape of the freeform surface of the output lens 1408 in the direction of a vertical field of view can, in some examples, have a symmetrical shape closed to a sphere with a radius of about −280 mm, such as shown in FIG. 15A. The cross-sectional shape of the freeform surface of the output lens 1408 in the direction of a horizontal field of view can, in some examples, have an asymmetrical shape closed to a sphere with a radius of about −400 mm, such as shown in FIG. 15B. FIG. 16 shows an example total shape of the freeform surface of the output lens 1408, which is similar to a biconic surface. The best fit sphere for the first surface of the output lens 1408 can be calculated as a sphere minimizing the sum of the squared residuals. The maximum deviation of the freeform surface of the output lens 1408 from the best fit sphere with a radius of −426.6 millimeters (mm) is approximately 4 mm, such as shown in FIG. 17.

Referring to FIGS. 2, 14A and 14B, the optical system 104 with the correcting optical unit 1400 operates as follows. The PGU 202 projects an intermediate image onto the diffuser 1414. Rays of light from the diffuser 1414 propagate through the correcting optical unit, wherein the inclined optical element 1404 and the output lens 1408 with the freeform surface create an optical path length monotonic variation in the direction of the horizontal field of view 1412, producing the modified optical images 212. The modified optical images 212 reach the combiner 206, which redirects the modified optical images 212 toward the eye box 208. An inclined virtual image surface, such as shown in FIG. 5, is formed by the monotonic variation of the optical path length with a non-zero angle α between the projection of a perpendicular through an arbitrary point of the virtual image surface onto the horizontal plane (defined as the X-Z plane) and the line-of-sight projection onto the horizontal plane.

2.4. Further Examples

In some examples, the optical system 104 can operate in monochromatic mode or in full-color mode with chromatism correction.

Table 1 shows example geometrical characteristics of the optical system 104.

TABLE 1

| | |
|---|---|
| FOV (degrees) | 14 (H) × 4 (V) |
| Eye-box (mm) | 130 × 60 |
| Off-Axis (degrees) | 8.6 |
| Vignetting (%) | 12.6 |
| Largest Optical Element Size (MM) | 200 × 132 |
| HOW Combiner Size (MM) | Ø 430 |

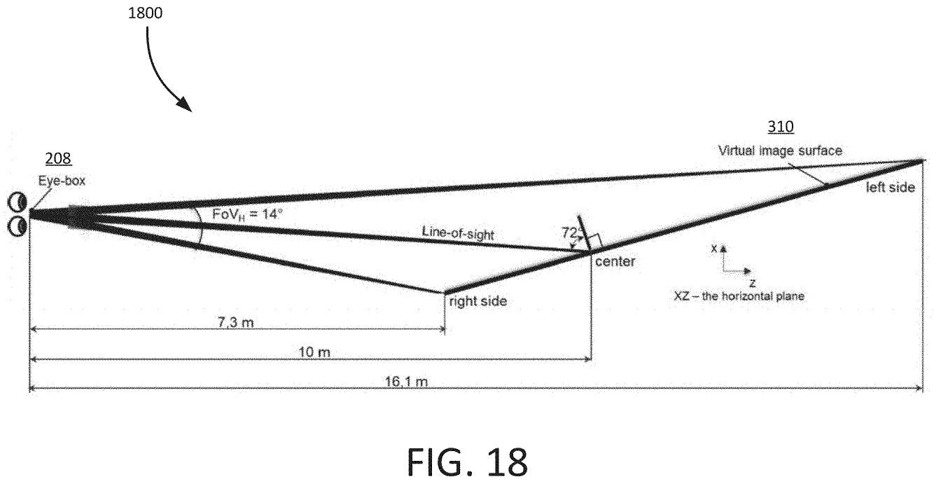

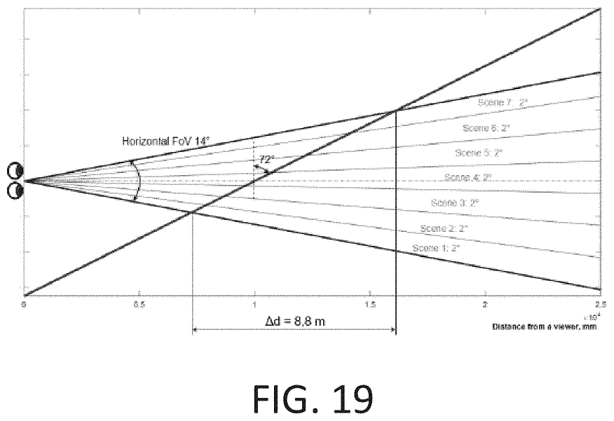

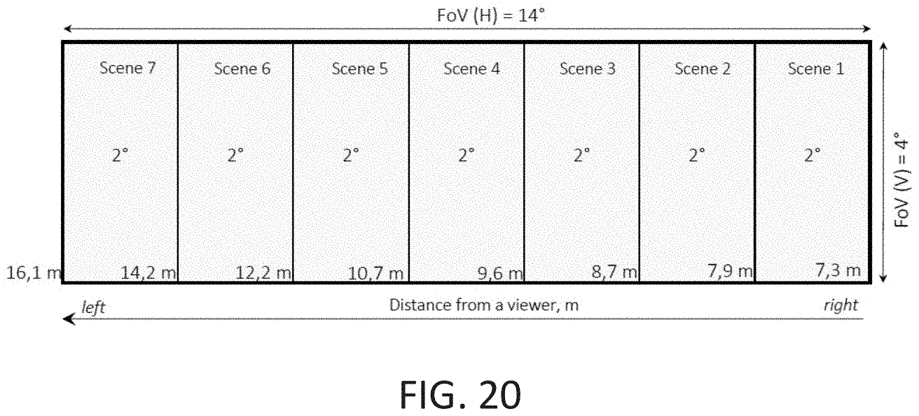

FIG. 18 is a top down view of a horizontal field of view 1800 of the optical system 104, in accordance with an example of the present disclosure. In this example, virtual objects on the right side of the field of view 1800 are displayed closer to a viewer than virtual objects on the left side of the field of view 1800. The angle between the projection of a perpendicular through an arbitrary point of the virtual image surface onto the horizontal plane and a line-of-sight projection onto the horizontal plane is 72°, which corresponds to 4.84 milliradians stereoscopic depth of field, with a 2° usable size and/or width of the virtual object (which isn't perceived as inclined) and seven (7) scenes in a three-dimensional virtual image, such as listed in Table 2 below and in FIG. 19. FIG. 20 shows scenes in the field of view defining several areas at predetermined distances from a viewer, where the displayed virtual objects aren't perceived as inclined. The size of each scene is limited by the usable size of the virtual object and the vertical field of view FoV(V).

Table 2 shows the stereoscopic depth of field parameters of the optical system 104, according to an example of the present disclosure. The usable size of the virtual object is listed for a stereo-threshold of 150 arc sec.

TABLE 2

| | |
|---|---|
| Virtual image surface inclination angle α (degrees) | 72 |
| Linear stereoscopic depth of field Δd (m) | 8.8 |
| Angular stereoscopic depth of field η (mrad) | 4.84 |
| Number of scenes | 7 |
| Usable size of the virtual object* (degrees) | 2 |

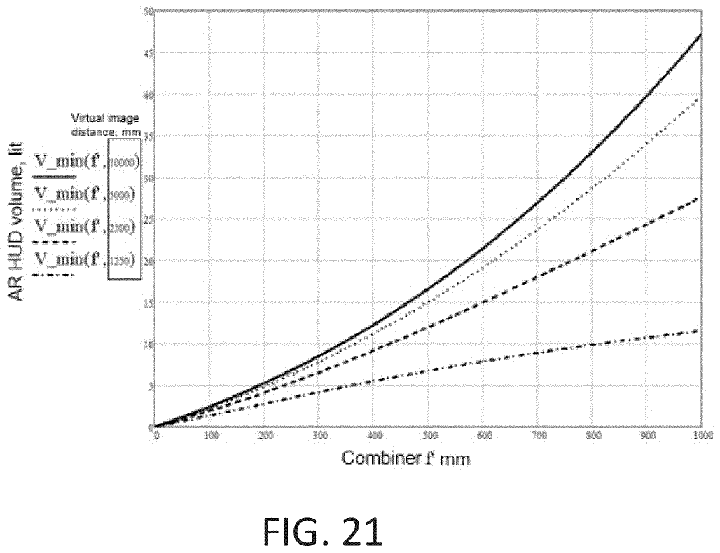

In some examples, to achieve a larger stereoscopic depth of field, the combiner 206 includes a HOE. An advantage of the holographic combiner in AR HUD optical systems is the ability to provide a wide field of view while maintaining the compactness of AR HUD. FIG. 21, for example, shows a dependence between the combiner focal length, the AR HUD volume, and the virtual image distance for a distance from the eye box to the combiner of about 700 mm with a circular eye-box radius of 71 mm and a field of view radius of 6.5 degrees. As shown in FIG. 21, the smaller the combiner focal distance (or the higher the combiner optical power), the smaller the volume of AR HUD which is needed to create a virtual image at distances above 3 m from a viewer. A combiner with low optical power can, for example, be incorporated into a windshield reflecting area and have focal lengths of more than about 1000 mm. By contrast, a holographic combiner, such as the combiner 206 of the optical system 104, in some examples, can have a small focal length (a high optical power about 1.1-6.6 diopters). Thus, for the same AR HUD volume, an AR HUD with a holographic combiner provides a wider field of view than AR HUD with a combiner having a low optical power. The result of the holographic combiner is an increased of the field of view and stereoscopic depth of field.

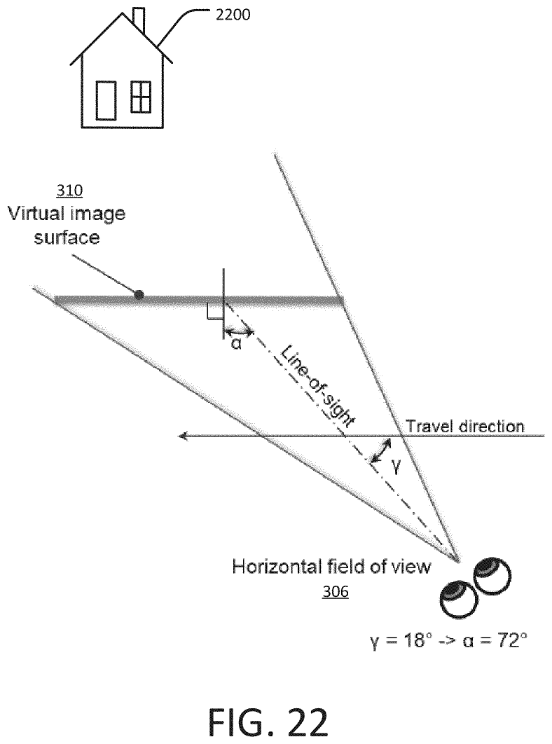

Another advantage, according to some examples of the present disclosure, is that the optical system 104 is suitable for integration into side-view AR HUDs, where a viewer observes the real world surrounding the vehicle 102 at an angle to the direction of travel, such as shown in FIG. 22. For example, while the vehicle 102 is moving, a passenger sitting near the side window is observing the real world surrounding at some angle γ relative to the travel direction, and it is natural that the passenger's eyes follow objects 2200 located along the road. To align the perspective of virtual objects observed by a viewer in the side-view AR HUD with the travel direction and to place the virtual objects along the road, the angle α (between a projection of a perpendicular through an arbitrary point of virtual image surface onto the horizontal plane and the line-of-sight projection onto the horizontal plane) can be matched in accordance with the angle γ between the line-of-sight and the travel direction.

### 3. Further Example Embodiments

The following examples describe further example embodiments, from which numerous permutations and configurations will be apparent.

Example 1 provides an optical system for an augmented reality head-up display. The optical system includes a picture generation unit; a correcting optical unit configured to create, in a direction of a horizontal field of view, a monotonic variation of an optical path length of light rays propagating from the picture generation unit; and a combiner configured to redirect light rays propagating from the correcting optical unit toward an eye box, thereby producing one or more virtual images observable from the eye box; wherein the optical system provides a virtual image surface inclined in the direction of the horizontal field of view for displaying the one or more virtual images at different distances from the eye box, the virtual image surface having a non-zero angle between projections on a horizontal plane defined by a first axis and a second axis, the first axis being perpendicular to the virtual image surface and extending through an arbitrary intersection point on the virtual image surface, the second axis being parallel to a line of sight and extending through the arbitrary intersection point on the virtual image surface, such that a virtual image on a first side of the virtual image surface appears closer to the eye box than a virtual image on a second side of the virtual image surface.

Example 2 includes the subject matter of Example 1, wherein the correcting optical unit includes at least one optical element having at least one optical surface inclined in the direction of the horizontal field of view.

Example 3 includes the subject matter of any one of Examples 1 and 2, wherein the correcting optical unit includes at least one optical element having at least one optical surface with an asymmetrical cross-sectional profile.

Example 4 includes the subject matter of Example 1, wherein the correcting optical unit includes a combination of at least one optical element inclined in the direction of the horizontal field of view and at least one optical surface with an asymmetrical cross-sectional profile.

Example 5 includes the subject matter of any one of Examples 1-4, wherein the combiner includes a holographic optical element with a positive optical power.

Example 6 includes the subject matter of any one of Examples 1-5, wherein the correcting optical unit includes a telecentric lens located between the picture generation unit and the optical element, the optical element including a lens with a cylindrical surface and an aspherical surface; a mirror located between the optical element and the combiner, the mirror including a cylindrical surface; and an output lens located between the mirror and the combiner, the output lens including a first surface and a second surface, the first surface having an aspherical cross-sectional profile, the second surface having a spherical cross-sectional profile.

Example 7 includes the subject matter of any one of Examples 1-5, wherein the correcting optical unit includes a telecentric lens located between the picture generation unit and the optical element, the optical element including a lens with a cylindrical surface and an aspherical surface; a mirror located between the optical element and the combiner, the mirror including the at least one optical surface, the at least one optical surface having a freeform shape with an asymmetrical cross-sectional profile; and an output lens located between the mirror and the combiner, the output lens including a first surface and a second surface, the first surface having an aspherical cross-sectional profile, the second surface having a spherical cross-sectional profile.

Example 8 includes the subject matter of any one of Examples 1-5, wherein the correcting optical unit includes a telecentric lens located between the picture generation unit and the optical element, the optical element including a lens with a cylindrical surface and an aspherical surface; a mirror located between the optical element and the combiner, the mirror including a cylindrical surface; and an output lens located between the mirror and the combiner, the output lens including a first surface and a second surface, the first surface having a freeform shape with an asymmetrical cross-sectional profile in the direction of the horizontal field of view, the second surface having a spherical cross-sectional profile.

Example 9 includes the subject matter of any one of Examples 1-8, wherein the inclined virtual image surface is approximately planar.

Example 10 includes the subject matter of any one of Examples 1-9, wherein the correcting optical unit is implemented for a side-view perception functionality and provides the inclined virtual image surface being aligned with a direction of travel of a vehicle.

Example 11 provides an optical system for an augmented reality head-up display. The optical system includes a picture generation unit configured to generate an optical image; a correcting optical unit configured to create, in a direction of a horizontal field of view, a monotonic variation of a plurality of optical path lengths of light rays in the optical image propagating from the picture generation unit, thereby producing a plurality of modified optical images; and a combiner configured to redirect the modified optical images propagating from the correcting optical unit toward an eye box, thereby producing one or more virtual images observable from the eye box; wherein the optical system provides a virtual image surface inclined in the direction of the horizontal field of view for displaying the one or more virtual images at different distances from the eye box, the virtual image surface having a non-zero angle between projections on a horizontal plane defined by a first axis and a second axis, the first axis being perpendicular to the virtual image surface and extending through an arbitrary intersection point on the virtual image surface, the second axis being parallel to a line of sight and extending through the arbitrary intersection point on the virtual image surface, such that a virtual image on a first side of the virtual image surface appears closer to the eye box than a virtual image on a second side of the virtual image surface.

Example 12 includes the subject matter of Example 11, wherein the correcting optical unit includes at least one optical element having at least one optical surface inclined in the direction of the horizontal field of view.

Example 13 includes the subject matter of any one of Examples 11 and 12, wherein the correcting optical unit includes at least one optical element having at least one optical surface with an asymmetrical cross-sectional profile.

Example 14 includes the subject matter of Example 11, wherein the correcting optical unit includes a combination of at least one optical element inclined in the direction of the horizontal field of view and at least one optical surface with an asymmetrical cross-sectional profile.

Example 15 includes the subject matter of any one of Examples 11-14, wherein the combiner includes a holographic optical element with a positive optical power.

Example 16 includes the subject matter of any one of Examples 11-15, wherein the correcting optical unit includes a telecentric lens located between the picture generation unit and the optical element, the optical element including a lens with a cylindrical surface and an aspherical surface; a mirror located between the optical element and the combiner, the mirror including a cylindrical surface; and an output lens located between the mirror and the combiner, the output lens including a first surface and a second surface, the first surface having an aspherical cross-sectional profile, the second surface having a spherical cross-sectional profile.

Example 17 includes the subject matter of any one of Examples 11-15, wherein the correcting optical unit includes a telecentric lens located between the picture generation unit and the optical element, the optical element including a lens with a cylindrical surface and an aspherical surface; a mirror located between the optical element and the combiner, the mirror including the at least one optical surface, the at least one optical surface having a freeform shape with an asymmetrical cross-sectional profile; and an output lens located between the mirror and the combiner, the output lens including a first surface and a second surface, the first surface having an aspherical cross-sectional profile, the second surface having a spherical cross-sectional profile.

Example 18 includes the subject matter of any one of Examples 11-15, wherein the correcting optical unit includes a telecentric lens located between the picture generation unit and the optical element, the optical element including a lens with a cylindrical surface and an aspherical surface; a mirror located between the optical element and the combiner, the mirror including a cylindrical surface; and an output lens located between the mirror and the combiner, the output lens including a first surface and a second surface, the first surface having a freeform shape with an asymmetrical cross-sectional profile in the direction of the horizontal field of view, the second surface having a spherical cross-sectional profile.

Example 19 includes the subject matter of any one of Examples 11-18, wherein the inclined virtual image surface is approximately planar.

Example 20 includes the subject matter of any one of Examples 11-19, wherein the correcting optical unit is implemented for a side-view perception functionality and provides the inclined virtual image surface being aligned with a direction of travel of a vehicle.

The foregoing description and drawings of various embodiments are presented by way of example only. These examples are not intended to be exhaustive or to limit the present disclosure to the precise forms disclosed. Alterations, modifications, and variations will be apparent in light of this disclosure and are intended to be within the scope of the present disclosure as set forth in the claims. Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. An optical system for an augmented reality head-up display, the optical system comprising:
a picture generation unit (PGU);
a correcting optical unit configured to create, in a direction of a horizontal field of view (HFoV), a monotonic variation of an optical path length of light rays propagating from the PGU; and
a combiner configured to redirect light rays propagating from the correcting optical unit toward an eye box, thereby producing one or more virtual images observable from the eye box;
wherein the optical system provides a virtual image surface inclined in the direction of the HFoV for displaying the one or more virtual images at different distances from the eye box, the virtual image surface having a non-zero angle between projections on a horizontal plane defined by a first axis and a second axis, the first axis being perpendicular to the virtual image surface and extending through an arbitrary intersection point on the virtual image surface, the second axis being parallel to a line of sight and extending through the arbitrary intersection point on the virtual image surface, such that a virtual image on a first side of the virtual image surface appears closer to the eye box than a virtual image on a second side of the virtual image surface.

2. The optical system of claim 1, wherein the correcting optical unit includes at least one optical element having at least one optical surface inclined in the direction of the HFoV.

3. The optical system of claim 1, wherein the correcting optical unit includes at least one optical element having at least one optical surface with an asymmetrical cross-sectional profile.

4. The optical system of claim 1, wherein the correcting optical unit includes a combination of at least one optical element inclined in the direction of the HFoV and at least one optical surface with an asymmetrical cross-sectional profile.

5. The optical system of claim 1, wherein the combiner includes a holographic optical element with a positive optical power.

6. The optical system of claim 5, wherein the correcting optical unit includes:
a telecentric lens located between the PGU and the optical element, the optical element including a lens with a cylindrical surface and an aspherical surface;
a mirror located between the optical element and the combiner, the mirror including a cylindrical surface; and
an output lens located between the mirror and the combiner, the output lens including a first surface and a second surface, the first surface having an aspherical cross-sectional profile, the second surface having a spherical cross-sectional profile.

7. The optical system of claim 5, wherein the correcting optical unit includes:
a telecentric lens located between the PGU and the optical element, the optical element including a lens with a cylindrical surface and an aspherical surface;
a mirror located between the optical element and the combiner, the mirror including at least one optical surface, the at least one optical surface having a freeform shape with an asymmetrical cross-sectional profile; and
an output lens located between the mirror and the combiner, the output lens including a first surface and a second surface, the first surface having an aspherical cross-sectional profile, the second surface having a spherical cross-sectional profile.

8. The optical system of claim 5, wherein the correcting optical unit includes:
a telecentric lens located between the PGU and the optical element, the optical element including a lens with a cylindrical surface and an aspherical surface;
a mirror located between the optical element and the combiner, the mirror including a cylindrical surface; and
an output lens located between the mirror and the combiner, the output lens including a first surface and a second surface, the first surface having a freeform shape with an asymmetrical cross-sectional profile in the direction of the HFoV, the second surface having a spherical cross-sectional profile.

9. The optical system of claim 1, wherein the inclined virtual image surface is approximately planar.

10. The optical system of claim 1, wherein the correcting optical unit is implemented for a side-view perception functionality and provides the inclined virtual image surface being aligned with a direction of travel of a vehicle.

11. An optical system for an augmented reality head-up display, the optical system comprising:
a picture generation unit (PGU) configured to generate an optical image;
a correcting optical unit configured to create, in a direction of a horizontal field of view (HFoV), a monotonic variation of a plurality of optical path lengths of light rays in the optical image propagating from the PGU, thereby producing a plurality of modified optical images; and
a combiner configured to redirect the modified optical images propagating from the correcting optical unit toward an eye box, thereby producing one or more virtual images observable from the eye box;
wherein the optical system provides a virtual image surface inclined in the direction of the HFoV for displaying the one or more virtual images at different distances from the eye box, the virtual image surface having a non-zero angle between projections on a horizontal plane defined by a first axis and a second axis, the first axis being perpendicular to the virtual image surface and extending through an arbitrary intersection point on the virtual image surface, the second axis being parallel to a line of sight and extending through the arbitrary intersection point on the virtual image surface, such that a virtual image on a first side of the virtual image surface appears closer to the eye box than a virtual image on a second side of the virtual image surface.

12. The optical system of claim 11, wherein the correcting optical unit includes at least one optical element having at least one optical surface inclined in the direction of the HFoV.

13. The optical system of claim 11, wherein the correcting optical unit includes at least one optical element having at least one optical surface with an asymmetrical cross-sectional profile.

14. The optical system of claim 11, wherein the correcting optical unit includes a combination of at least one optical element inclined in the direction of the HFoV and at least one optical surface with an asymmetrical cross-sectional profile.

15. The optical system of claim 11, wherein the combiner includes a holographic optical element with a positive optical power.

16. The optical system of claim 15, wherein the correcting optical unit includes:
a telecentric lens located between the PGU and the optical element, the optical element including a lens with a cylindrical surface and an aspherical surface;
a mirror located between the optical element and the combiner, the mirror including a cylindrical surface; and
an output lens located between the mirror and the combiner, the output lens including a first surface and a second surface, the first surface having an aspherical cross-sectional profile, the second surface having a spherical cross-sectional profile.

17. The optical system of claim 15, wherein the correcting optical unit includes:
a telecentric lens located between the PGU and the optical element, the optical element including a lens with a cylindrical surface and an aspherical surface;
a mirror located between the optical element and the combiner, the mirror including at least one optical surface, the at least one optical surface having a freeform shape with an asymmetrical cross-sectional profile; and
an output lens located between the mirror and the combiner, the output lens including a first surface and a second surface, the first surface having an aspherical cross-sectional profile, the second surface having a spherical cross-sectional profile.

18. The optical system of claim 15, wherein the correcting optical unit includes:
a telecentric lens located between the PGU and the optical element, the optical element including a lens with a cylindrical surface and an aspherical surface;
a mirror located between the optical element and the combiner, the mirror including a cylindrical surface; and
an output lens located between the mirror and the combiner, the output lens including a first surface and a second surface, the first surface having a freeform shape with an asymmetrical cross-sectional profile in the direction of the HFoV, the second surface having a spherical cross-sectional profile.

19. The optical system of claim 11, wherein the inclined virtual image surface is approximately planar.

20. The optical system of claim 11, wherein the correcting optical unit is implemented for a side-view perception functionality and provides the inclined virtual image surface being aligned with a direction of travel of a vehicle.
